(19) United States
(12) Patent Application Publication
(10) Pub. No.: US 2007/0087894 A1
(43) Pub. Date: Apr. 19, 2007

(54) Engine starting control apparatus of hybrid drive system

(75) Inventors: Takashi Tsuneyoshi, Yokohama (JP); Yuusuke Minagawa, Kanagawa (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/582,557

(22) Filed: Oct. 18, 2006

(30) Foreign Application Priority Data
Oct. 19, 2005 (JP) 2005-304789

(51) Int. Cl. B60K 1/02

(52) U.S. Cl. 477/3

(57) ABSTRACT

An engine staring control apparatus of a hybrid drive system is arranged to increase the torque transmission capacity such that a cranking torque of an engine is compensated when the engine is started; to stop the increase of the torque transmission capacity when a revolution speed of an engine-side friction element of an engine clutch reaches a revolution speed at which the engine can start by itself; to hold a torque transmission capacity of the engine clutch after the stopping of the increase of the torque transmission capacity; and to stop the holding of the torque transmission capacity and to again increase the torque transmission capacity when the revolution speed of the engine-side friction element reaches the revolution speed of a transmission-side friction element.

### BACKGROUND OF THE INVENTION

The present invention relates to a technique for starting an internal combustion engine using a motor/generator in a hybrid vehicle equipped with the motor/generator and the internal combustion engine which act as a drive power source.

In a hybrid vehicle of a type that an engine is drivingly connected with a transmission equipped with a motor/generator (such a transmission is referred to as a hybrid transmission), there is known a technique for controlling a starting of an engine using an output of the motor/generator during a running state. Such a technique has been disclosed in Japanese Published Patent Application No. 2002-349310.

The hybrid vehicle disclosed in Japanese Published Patent Application No. 2002-349310 is comprised of a driveline constructed by connecting an engine output shaft with an end of a motor output shaft through a hydraulic clutch and by connecting the other end of the motor output shaft with an automatic transmission. In case that an engine is started during a motor running state of operating only the motor/generator by disengaging the hydraulic clutch, the output torque of the motor is firstly increased by gradually increasing a clutch pressure command value of the hydraulic clutch, and when a difference between an engine revolution speed and the motor revolution speed reaches a predetermined value, the hydraulic clutch is fully engaged by sharply increasing the clutch pressure command value.

### SUMMARY OF THE INVENTION

However, this hybrid vehicle has the following problem. As shown by broken lines in FIG. 5, a conventional engine starting control of this hybrid vehicle is arranged to continue an increase of the clutch pressure command value, and therefore a clutch transmission capacity thereof is increased in proportion to the clutch pressure command value as shown by a broken line a. Since the motor/generator put in a high revolution speed state during vehicle running is dragged by the engine put in a stop state or a low revolution speed state due to the increase of the clutch transmission capacity, it is necessary to continuously increase the output torque of the motor/generator according to the increase of the clutch pressure command value so as not to decrease the motor revolution speed, that is, so as to apply a cranking torque for starting the engine to the engine, during a period from a moment t1 to moment t2 in FIG. 5. As a result, it is necessary to be equipped with a large motor as a drive power source so as to be capable of generating a large torque as shown by a broken line b during the period from moment t1 to moment t2 in FIG. 5. This causes a problem that the driveline becomes large in size and weight.

It is therefore an object of the present invention to provide a starting control apparatus of a hybrid drive system, which is achieved without increasing the motor/generator in size and weight.

An aspect of the present invention resides in an engine staring control apparatus of a hybrid drive system, which is constructed by drivingly connecting a hybrid transmission equipped with a motor/generator as a driving source and an internal combustion engine through a friction engagement element. The engine starting control apparatus comprises a friction engagement element controlling section controlling a torque transmission capacity of the friction engagement element; a torque controlling section controlling a torque outputted from the motor/generator; an engine-side revolution speed calculating section obtaining a revolution speed of an engine-side friction element of the friction engagement element; a transmission-side revolution speed calculating section obtaining a revolution speed of a transmission-side friction element of the friction engagement element; the torque controlling section compensating a cranking torque when the engine is started; the friction engagement element controlling section increasing the torque transmission capacity when the engine is started; the friction engagement element controlling section stopping the increase of the torque transmission capacity and holding the torque transmission capacity when the revolution speed of the engine-side friction element reaches a revolution speed at which the engine can start by itself; and the friction engagement element controlling section stopping the holding of the torque transmission capacity and again increasing the torque transmission capacity when the revolution speed of the engine-side friction element reaches the revolution speed of the transmission-side friction element.

Another aspect of the present invention resides in a method for controlling a starting of an internal combustion engine of a hybrid drive system, which is constructed by drivingly connecting a hybrid transmission equipped with a motor/generator as a driving source and the engine through a friction engagement element. The engine starting control method comprises an operation of obtaining a revolution speed of an engine-side friction element of the friction engagement element; an operation of obtaining a revolution speed of a transmission-side friction element of the friction engagement element; an operation of increasing a torque transmission capacity of the friction engagement element and of compensating a cranking torque outputted from the motor/generator when the engine is started; an operation of stopping the increase of the torque transmission capacity and of holding the torque transmission capacity when the revolution speed of the engine-side friction element reaches a revolution speed at which the engine can starts by itself; and an operation of stopping the holding of the torque transmission capacity and of again increasing the torque transmission capacity when the revolution speed of the engine-side friction element reaches the revolution speed of the transmission-side friction element.

A further aspect of the present invention resides in an engine staring control apparatus of a hybrid drive system which is constructed by drivingly connecting a hybrid transmission equipped with a motor/generator as a driving source and an internal combustion engine through a friction element. The engine starting control apparatus comprises a controller which is programmed to obtain a revolution speed of an engine-side friction element of the friction engagement element, to obtain a revolution speed of a transmission-side friction element of the friction engagement element, to compensate a cranking torque when it is determined that the engine is started, to increase the torque transmission capacity when it is determined that the engine is started, to stop the increase of the torque transmission capacity when the revolution speed of the engine-side friction element reaches a revolution speed at which the engine can start by itself, to hold the torque transmission capacity when the revolution speed of the engine-side friction element reaches the revolution speed at which the engine can start by itself, to stop the holding of the torque transmission capacity just after the revolution speed of an engine-side friction element temporally becomes higher than the revolution speed of the transmission-side friction element, and to again increase the torque transmission capacity just after the revolution speed of an engine-side friction element temporally becomes higher than the revolution speed of the transmission-side friction element.

The other objects and features of this invention will become understood from the following description with reference to the accompanying drawings.

### BRIEF DESCRIPTION OF THE DRAWINGS

FIG. 1 is a schematic plan view showing a power train of a vehicle equipped with a hybrid drive system to which a concept of the present invention is applied.

FIG. 2 is a lever diagram showing a relationship among revolution speeds and a relationship among torques of rotating members constituting a differential device of the hybrid drive system.

FIG. 3 is a block diagram showing a control system of the power train of the vehicle equipped with the hybrid drive system.

FIG. 4 is a flowchart showing a control for starting an internal combustion engine, which is executed by the control system of an engine starting control apparatus according to the embodiment of the present invention.

FIG. 5 is an operational timing chart under a situation that a polarity of a compensation torque is momentarily inverted when a revolution speed difference is 0, according to an embodiment of the present invention, and an operational timing chart of a comparatively exemplified prior art.

FIG. 6 is an operational timing chart under a situation that the polarity of the compensation torque is momentarily inverted when the revolution speed difference is Nd, according to the embodiment of the present invention.

FIG. 7 is an operational timing chart under a situation that the polarity of the compensation torque is temporally set at 0 when the polarity of the compensation torque is inverted, according to the embodiment of the present invention.

FIG. 8 is an operational timing chart under a situation that the polarity of the compensation torque is inverted at a constant rate of change per unit time, according to the embodiment of the present invention.

FIG. 9 is an operational timing chart under a situation that the polarity of the compensation torque is inversed using a trigonometric function, according to the embodiment of the present invention.

FIG. 10 is an operational timing chart under a situation that the compensation of the torque is started when a torque transmission capacity command value reaches a compensation starting torque, according to the embodiment of the present invention.

FIG. 11 is an operational timing chart under a situation that the compensation torques of first and second motor/generators are separately controlled and the total of the compensation torques is temporally set at 0, according to the embodiment of the present invention.

FIG. 12 is an operational timing chart under a situation that the compensation torques of first and second motor/generators are separately controlled and the polarity of the total of the compensation torques is inverted at a constant rate of change per unit time, according to the embodiment of the present invention.

FIG. 13 is an operational timing chart under a situation that the compensation torques of the first and second motor/generators are separately controlled and the polarity of the total of the compensation torques is inverted using a trigonometric function, according to the embodiment of the present invention.

### DETAILED DESCRIPTION OF THE INVENTION

Hereinafter, there is described an embodiment according to the present invention on the basis of the drawings.

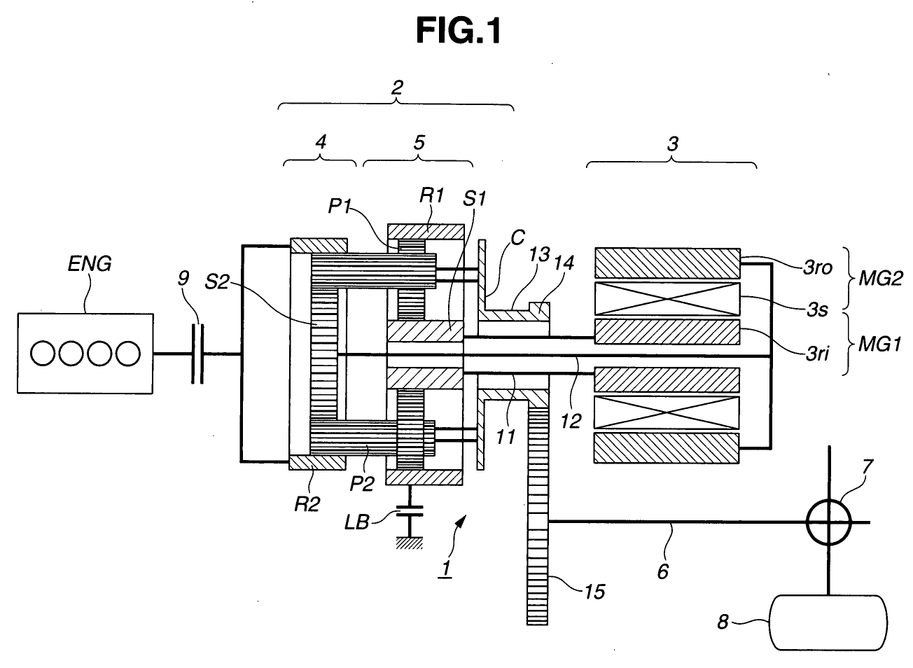

FIG. 1 shows a hybrid transmission 1 of a hybrid vehicle equipped with an engine starting control apparatus. In this embodiment, hybrid transmission 1 is constructed as a transaxle for a front-wheel-drive vehicle (FF vehicle). A Ravigneaux planetary gearset 2 and a compound-current double-layer motor 3 are built in a not-shown transmission case so that Ravigneaux planetary gearset 2 is located at the left-hand side along the axial direction of the transmission case (not shown) and a compound-current double-layer motor 3 located at the right-hand side along the axial direction of the transmission case in FIG. 1. Further at a left-hand side of Ravigneaux planetary gearset 2, an internal combustion engine ENG is coaxially located while being disposed outside of the transmission case.

Ravigneaux planetary gearset 2 and compound-current double-layer motor 3 are coaxially arranged on a main axis of the hybrid transmission in the transmission case. A counter shaft 6 and a differential gear device 7 are also built in the transmission case so as to be parallel with the main axis while being offset from the main axis. Left and right driving wheels 8 are drivingly connected with differential gear device 7.

Ravigneaux planetary gearset 2 is constructed by a combination of a single-pinion planetary gearset 4 and a double-pinion planetary gearset 5 which commonly employ long pinions P2. Single-pinion planetary gearset 4 is located near engine ENG as compared with the location of double-pinion planetary gearset 5. Single-pinion planetary gearset 4 is constructed by engaging long pinions P2 with a sun gear S2 and a ring gear R2. Double-pinion planetary gearset comprises common long pinions P2, a sun gear S1, a ring gear R1 and large-diameter short pinions P1 which engage with sun gear S1, ring gear R1 and common long pinions P2. Double-pinion planetary gearset is constructed by engaging common long pinions P2 with short pinions P1. All of pinions P1 and P2 of planetary gearsets 4 and 5 are rotatably supported by a common carrier C.

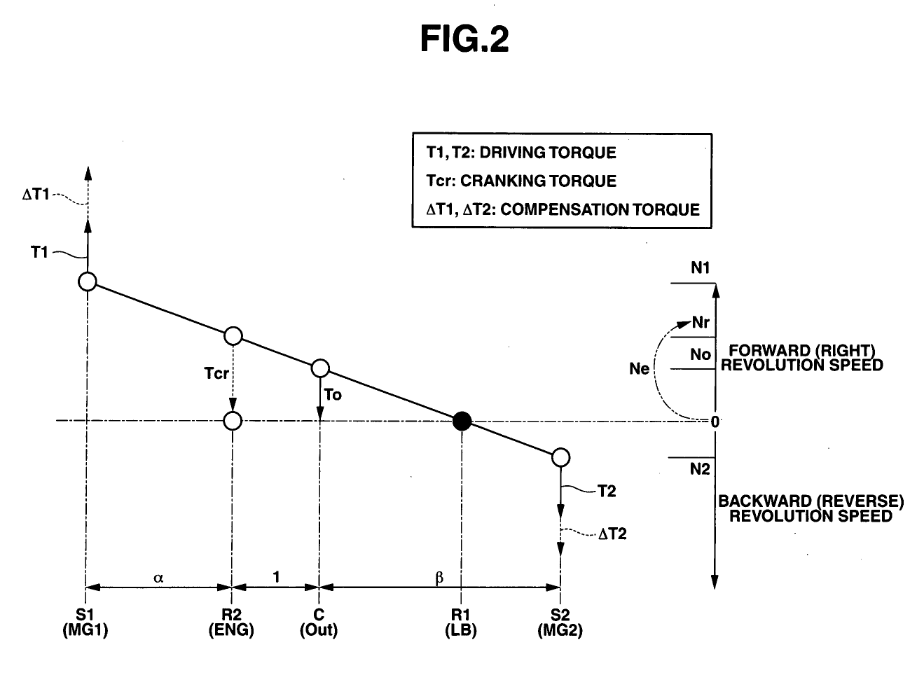

Ravigneaux planetary gearset 2 mainly comprises five rotating members, which are sun gear S1, sun gear S2, ring gear R1, ring gear R2 and carrier C. When rotating conditions of two of the rotating members in Ravigneaux planetary gearset 2 are determined, rotating conditions of all of the rotating members are determined. That is to say, Ravigneaux planetary gearset 2 is a two-degree-of-freedom differential mechanism having five rotating elements. As is clear from a lever diagram shown in FIG. 2, the sequence of revolution speeds of the five rotating members is arranged in the sequence of sun gear S1, ring gear R2, carrier C, ring gear R1 and sun gear S2.

Compound-current double-layer motor 3 comprises an inter rotor 3ri, an annular outer rotor 3ro surrounding inner rotor 3ri and an annular stator coil 3s. Inner and outer rotors 3ri and 3ro are coaxially and rotatably supported in the transmission case. Annular stator coil 3s acting as a stator of compound-current double-layer motor 3 is disposed in an annular space defined between the outer periphery of inner rotor 3ri and the inner periphery of outer rotor 3ro and fixedly connected to the transmission case. Annular stator coil 3s and inner rotor 3ri construct a first motor/generator (inner motor/generator) MG1, and annular stator coil 3s and outer rotor 3ro construct a second motor/generator (outer motor/generator) MG2.

In this embodiment, a compound multiphase alternating current (AC) multi-layer (double-layer) motor 3, which has multiple motors (two rotors in this embodiment) and is driven by compound multiphase AC, is employed as first and second motor/generators MG1 and MG2. Further, compound-current double-layer motor 3 is arranged such that the number of pole pairs of inner rotor 3ri is different from the number of pole pairs of outer rotor 3ro. Outer and inner rotors 3ro and 3ri of first and second motor/generators MG1 and MG2 are therefore driven independently of each other in revolution speed and in revolution direction by compounding a control current applied to one of the motor/generator set and a control current applied to the other.

When compound multiphase alternating current is supplied to each of first and second motor/generators MG1 and MG2, each of motor/generators MG1 and MG2 functions as an electric motor which outputs a rotational force having a revolution direction corresponding to a current direction and a revolution speed corresponding to a current strength of the supplied current. When no compound multiphase alternating current is supplied to each of first and second motor/generators MG1 and MG2, each of first and second motor/generators MG1 and MG2 functions as a generator which outputs an electric power corresponding to the magnitude of torque applied by way of an external force.

As is shown by the lever diagram in FIG. 2, sun gear S1, ring gear R2, carrier C, ring gear R1, and sun gear S2, which are five rotating members of Ravigneaux planetary gearset 2, are connected to first motor/generator MG1, an input connected to engine ENG, an output Out connected to a wheel driveline of wheels 8, a low brake LB, and second motor/generator MG2, respectively, in mentioned sequence. This mentioned sequence of the five rotating members are arranged in the sequence of the revolution speeds from the highest revolution speed.

There is discussed the connection of the five rotating members of Ravigneaux planetary gearset 2 in detail with reference to FIGS. 1 and 2.

Ring gear R2 acts as an input element, through which the power of engine ENG is inputted to the hybrid transmission. That is, ring gear R2 is connected to a crankshaft of engine ENG through an engine clutch 9. Sun gear S1 is connected to first motor/generator MG1 (inner rotor 3ri) through a hollow shaft 11 extending in the direction opposite to engine ENG. Sun gear S2 is connected to second motor/generator MG2 (outer rotor 3ro) through a center shaft 12, which is rotatably supported by second motor/generator MG2 and hollow shaft 11. Low brake LB for fixing a transmission ratio of hybrid transmission 1 at a low-side ratio is provided at ring gear R1 so that the driving force of driving wheels 8 is increased by the engagement of brake LB.

In order to operate carrier C as an output element for outputting the revolution in the transmission to the wheel driveline, carrier C is connected to an output gear 14 through a hollow connecting member (output shaft) 13. Accordingly, carrier C is disposed between Ravigneaux planetary gearset 2 and compound-current two-layer motor 3 so as to be rotatably supported in the transmission case. Output gear 14 is disposed between Ravigneaux planetary gearset 2 and compound-current double-layer motor 3 and is engaged with a counter gear 15 integrally connected to counter shaft 6. The transmission output revolution outputted from output gear 14 is transmitted to differential gear device 7 through counter gear 15 and counter shaft 6 and is distributed to the right and left drive wheels 8 through differential gear device 7. This transmitting line constitutes a wheel driveline.

The hybrid transmission in the embodiment of the present invention is represented by the lever diagram shown in FIG. 2. A horizontal axis of such a lever diagram represents a ratio of distances among the rotating members determined by a gear ratio of planetary gearsets 4 and 5. More specifically, when a distance between ring gear R2 and carrier C is set at 1, a distance between sun gear S1 and ring gear R2 is represented by α, and a distance between carrier C and sun gear S2 is represented by β.

A vertical axis of the lever diagram represents a revolution speed of each rotating member. More specifically, in the lever diagram, there are represented an engine revolution speed Ne toward ring gear R2 through engine clutch 9 (Ne is an engine side revolution speed of engine clutch 9, a revolution speed of ring gear R2 is a transmission side revolution speed of engine clutch 9), a revolution speed N1 of sun gear S1 (first motor/generator MG1), a revolution speed No of output Out from carrier C, a revolution speed N2 of sun gear S2 (second motor/generator MG2), and a revolution speed of ring gear R1. If the revolution speeds of two of the rotating members are determined, the revolution speeds of the other rotating members are determined.

There is discussed a shift operation of the hybrid transmission 1 with reference to the lever diagram shown in FIG. 2. The lever diagram shown in FIG. 2 represents a situation that a torque To of transmission output shaft Out is outputted by a driving force (the motor output torques are represented by T1 and T2) from first and second motor/generators MG1 and MG2 (or one of motor/generators) as a result of the engagement of low brake LB.

During an electric running using an electric running mode where engine clutch (friction engagement element) 9 is disengaged and engine ENG is put in a stop state (engine revolution speed Ne=0), in case that an engine driving force is required due to the increase of the demand driving force of transmission output shaft torque To, engine cranking is executed by engaging engine clutch 9 so that engine revolution speed Ne (the engine-side revolution speed of engine clutch 9) is increased from 0 toward revolution speed Nr (the transmission-side revolution speed of engine clutch 9) of ring gear R2 as shown by an arrow of a two-dot chain line in FIG. 2, and simultaneously engine ENG is started by injecting fuel in engine ENG. By these operations, a running mode is transferred from the electric running mode to a hybrid running mode which employs the engine driving force.

A cranking torque Tcr necessary for executing the cranking of engine ENG is obtained in a manner that motor/generators MG1 and MG2, which are generating torques T1 and T2 necessary for a drive running, increase the outputs so as to compensate the cranking torque Tcr without decreasing torque T1 and T2. More specifically, cranking torque Tcr is obtained as a total of a compensation torque ΔT1 outputted from first motor/generator MG1 and a compensation torque ΔT2 outputted from second motor/generator MG2 as shown in FIG. 2. Cranking torque Tcr may be obtained only by compensation torque ΔT1 outputted from first motor/generator MG1 or only by compensation torque ΔT2 outputted from second motor/generator MG2.

During the hybrid running mode after the changeover from the electric running mode, revolution speed No of output Out is determined by the driving force outputted from engine ENG (engine clutch 9) and the driving force outputted from first and second motor/generators MG1 and MG2 (or one of first and second motor/generators). The torques T1 and T2 of motor/generators MG1 and MG2, engine output torque Te and transmission output torque To, which is in proportion to the demand driving force, are balanced so that the total of these torques becomes 0. Further, revolution speeds N1 and N2 of motor/generators MG1 and MG2, engine revolution speed Ne and transmission output revolution speed No (in proportion to vehicle speed) have a proportional relationship as represented by the lever in FIG. 2.

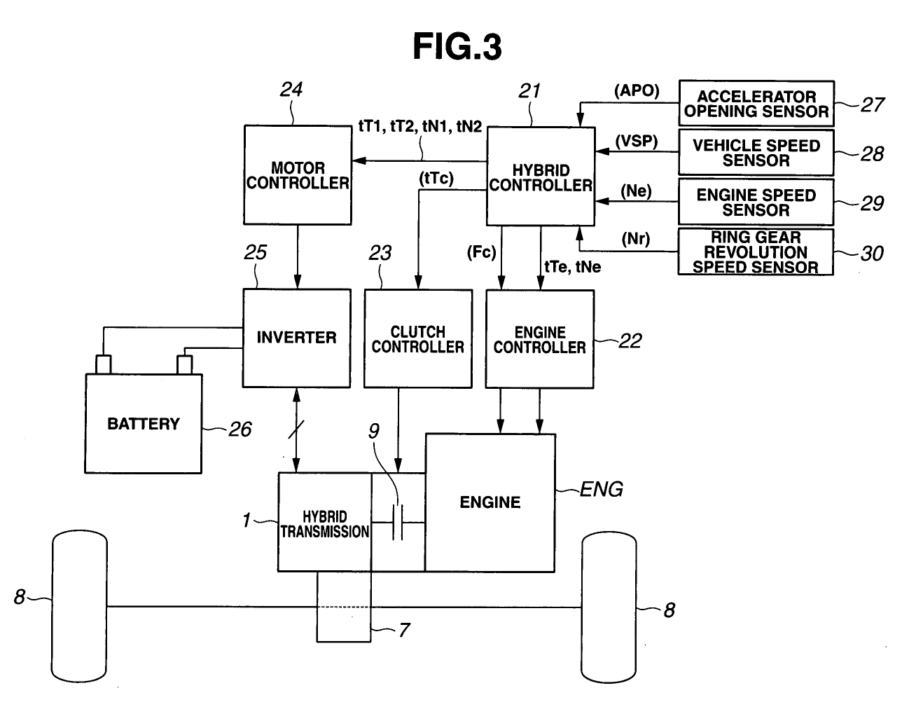

A system shown in FIG. 3 executes a shift control of the hybrid transmission and an engine clutch engagement control, which is executed when engine ENG is started by engaging engine clutch 9 for a changeover from the electric running mode to the hybrid running mode.

A hybrid controller 21 shown in FIG. 3 manages an integration control of engine ENG and hybrid transmission 1. Hybrid controller 21 supplies commands regarding a target torque tTe and a target revolution speed tNe of engine ENG and a fuel injection command Fc to an engine controller 22. Engine controller 22 controls the fuel injection to engine ENG according to the ON-OFF state of fuel injection command Fc, and controls engine ENG so as to achieve target values tTe and tNe.

Hybrid controller 21 supplies a command regarding a target torque (clutch engagement capacity) tTc of engine clutch 9 to clutch controller 23. Clutch controller 23 controls the engagement force of engine clutch 9 so as to achieve target torque (clutch engagement capacity) tTc. Engine clutch 9 may be of a hydraulic type or of an electromagnetic type, and achieves the target torque (clutch engagement capacity) by controlling a hydraulic pressure or an electromagnetic force according to the type of engine clutch 9.

Hybrid controller 21 supplies commands regarding target torques tT1 and tT2 and target revolution speeds tN1 and tN2 of motor/generators MG1 and MG2 to a motor controller 24. Motor controller 24 controls motor/generators MG1 and MG2 using an inverter 25 and a battery 26 so as to achieve target torques tT1 and tT2 and target revolution speeds tN1 and tN2 of motor/generators MG1 and MG2. Motor/generators MG1 and MG2 have a high responsibility which enables actual output torques T1 and T2 or actual output revolution speeds N1 and N2 to follow target torques tT1 and tT2 or target revolution speeds tN1 and tN2 of motor/generators MG1 and MG2.

Hybrid controller 21 for the shift control and the engagement control of engine clutch 9 receives a signal outputted from an accelerator opening sensor 27 for detecting an accelerator pedal depression quantity (accelerator opening) APO, a signal outputted from a vehicle speed sensor 28 for detecting a vehicle speed VSP (in proportion to output revolution speed No), a signal outputted from an engine speed sensor 29 for detecting an engine revolution speed (engine-side revolution speed of engine clutch 9) and a signal outputted from a ring gear revolution speed sensor 30 for detecting a revolution speed (transmission-side revolution speed of engine clutch 9) of ring gear R2.

Hybrid controller 21 determines the running mode on the basis of a demanded driving force F, vehicle speed VSP and a storage state (dischargeable electric power) of a battery 26, which are obtained from input information to hybrid controller 21, and executes the shift control according to the running mode determined. Further, hybrid controller 21 determines target engine torque tTe and target motor/generator torques tT1 and tT2 and outputs the commands regarding target engine torque tTe and target motor/generator torques tT1 and tT2 to engine controller 22 and motor controller 24. Since these controls are commonly known and does not relate to the present invention, the explanation thereof is omitted herein.

The information regarding the revolution speeds of the rotating elements, which is inputted to hybrid controller 21, is not limited to engine revolution speed Ne and vehicle speed VSP (output revolution speed No). A differential constructed by Ravigneaux planetary gearset 2 is equipped with a two-degree-of-freedom, and therefore revolution speeds of non-limited two of the rotating members in Ravigneaux planetary gearset 2 may be inputted to hybrid controller 21.

Hereinafter, there is discussed the engagement control of engine clutch 9, which is used to start engine ENG during a changeover from the electric running mode to the hybrid running mode, in detail.

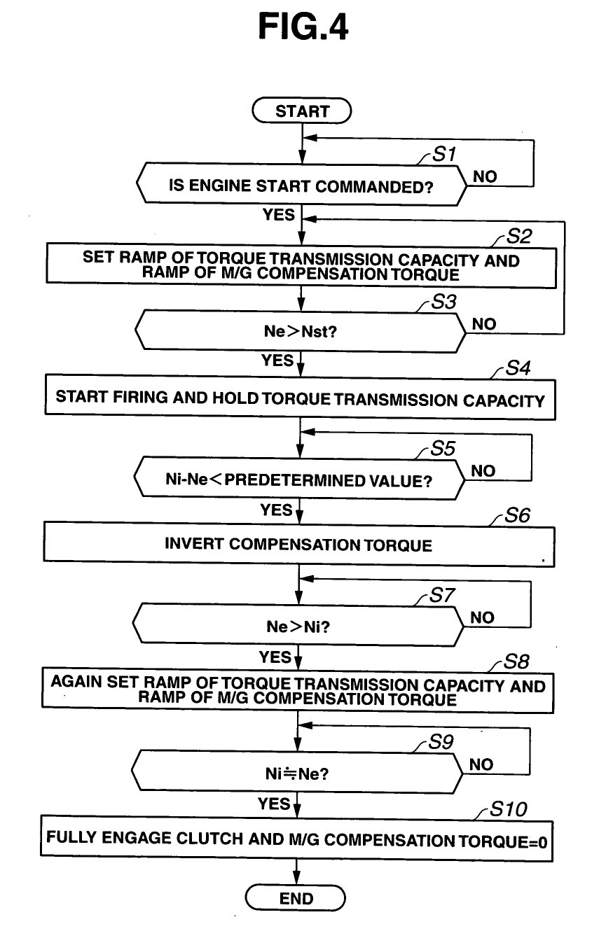

In case that the hybrid vehicle is running under the electric running mode (EV running), if the hybrid running mode (HEV running) is demanded, it is necessary to start engine ENG. In the embodiment according to the present invention, a processing shown by a flowchart shown in FIG. 4 is executed to start engine ENG. More specifically, the processing controls the engagement of engine clutch 9 and the outputs of the motor/generators MG1 and MG2 to start engine ENG.

The processing in FIG. 4 is an interruption processing, which is repeatedly executed at predetermined intervals, such as, at 10 millisecond intervals. At step S1, it is determined whether or not it is necessary to start engine ENG put in a stop state according to a determination of the changeover from the electric running mode to the hybrid running mode. When the determination at step S1 is negative, that is, when it is not necessary to start engine ENG, the program returns to step S1 to continue the monitoring as to the engine starting demand. When the determination at step S1 is affirmative, that is, when it is necessary to start engine ENG, the program proceeds to step S2.

At step S2 the torque transmission capacity of engine clutch 9 is set so as to be gradually increased with a predetermined ramp (gradient). In conjunction with this setting, compensation torques of motor/generators MG1 and MG2 are set so as to be gradually increased with a second predetermined ramp. More specifically, a hydraulic pressure supplied to a piston and a cylinder of engine clutch 9 is controlled so that the torque transmission capacity set at 0 under the electric running mode is gradually increased with the predetermined ramp. Further, in conjunction with the gradual increase of the torque transmission capacity, compensation torques of motor/generators MG1 and MG2 are gradually increased. Simultaneously with the gradual increase of the torque transmission capacity with the ramp, the compensation torques of motor/generators MG1 and MG2 may be gradually increased with a ramp. Further, the gradual increase of the compensation torque may be started after the gradual increase of the torque transmission capacity, upon taking account of a response delay of engine clutch 9. The processing at step S2 is for increasing the output torques of motor/generator MG1 and MG2 so as to compensate a dragging torque acting to lower the transmission-side revolution speed of engine clutch 9. In other words, engine clutch 9 acts to apply the cranking torque from motor/generators MG1 and MG2 to engine ENG.

At step S3, it is determined whether or not engine revolution speed Ne reaches an engine start enabling revolution speed Nst at which engine ENG can start by itself. When the determination at step S3 is negative, that is, when engine revolution speed Ne, which is increasing from 0, does not reach the engine start enabling revolution speed Nst, the program returns to step S2 wherein the compensation torques of motor/generators MG1 and MG2 are gradually increased by gradually increasing the torque transmission capacity of engine clutch 9. In contrast, when the determination at step S3 is affirmative, that is, when engine revolution speed Ne reaches engine start enabling revolution speed Nst by the gradual increase of the torque transmission capacity and the compensation torques, the program proceeds to step S4.

At step S4, firing of engine ENG is started, and the torque transmission capacity of engine clutch 9 is held at a previous value taken just before the firing. By holding the torque transmission capacity at the previous value in a manner of stopping the step S2 processing of increasing the torque transmission capacity, the cranking of engine ENG is executed. Further, this prevents the lowering of the revolution speeds N1 and N2 of motor/generators MG1 and MG2 due to the dragging by the engine revolution speed Ne operating at a low speed. Further, the fuel injection to engine ENG is also started. Further, in conjunction with the holding of the torque transmission capacity, the compensation torques of motor/generators MG1 and MG2 are held at previous values taken immediately before the execution of this step S4.

Since the torque transmission capacity is temporally held, engine clutch 9 is put in a slipping engagement state, and therefore the engine revolution speed Ne overshoots the transmission-side revolution speed Ni. Therefore, at step S5, it is determined whether or not a difference Ni−Ne between the revolution speed Ni of the transmission-side friction element of engine clutch 9 and the revolution speed Ne of the engine-side friction element of engine clutch 9 is within a predetermined threshold in order to detect an overshoot or a sign of the overshoot. The predetermined threshold may be 0 or may be a positive value as discussed later.

When the determination at step S5 is negative, that is, when the difference Ni−Ne is greater than or equal to the predetermined threshold, the program repeats step S5 to continue the monitoring as to the difference Ni−Ne. When the determination at step S5 becomes affirmative, the program proceeds to step S6.

At step S6, the polarities of the compensation torques of motor/generators MG1 and MG2 are inverted. More specifically, the torques applied from motor/generators MG1 and MG2 to engine ENG as a cranking torque is inverted so as to apply a braking torque from motor/generator MG1 and MG 2 to engine ENG. By this arrangement, it becomes possible to decrease the overshot revolution speed. The processing executed at step S6 may be a processing of momentarily inverting the polarity of the compensation torque. As discussed later, when the polarity of the compensation torque is inverted, the compensation torque may be temporally held at 0, may be varied at a constant rate of change per unit time (constant ramp) or may be smoothly varied using a trigonometric function.

At step S7, it is determined whether or not the revolution speed Ne (engine revolution speed) of the engine-side friction element of engine clutch 9 is greater than the revolution speed Ni of the transmission-side friction element of engine clutch 9. During the overshoot of the engine revolution speed Ne with respect to the revolution speed Ni of the transmission-side friction element, the determination at step S7 is affirmative, and therefore the program proceeds to step S8 during the overshoot.

At step S8, the torque transmission capacity of engine clutch 9 is again set so as to be gradually increased with the predetermined ramp, and the compensation torques of motor/generators MG1 and MG2 are again set so as to be gradually increased with the predetermined ramp. The processing of step S8 is executed to increase the braking torque (compensation torques) of motor/generators MG1 and MG2 so as to adjust the torque transmission capacity to the torques gradually increased, by again increasing the torque transmission capacity of engine clutch 9, which was held at step S4.

At step S9, it is determined whether or not the revolution speed (engine speed) Ne of the engine-side friction element is nearly equal to the revolution speed Ni of the transmission-side friction element. When the determination at step S9 is negative, that is, when the revolution speed Ne is not nearly equal to the revolution speed Ni, the program repeats step S9 to continue the monitoring until the revolution speed Ne becomes nearly equal to the revolution speed Ni. In contrast, when the determination at step S9 is affirmative, that is, when the revolution speed Ne is nearly equal to the revolution speed Ni, the program proceeds to step S10.

At step S10, engine clutch 9 is fully engaged by sufficiently increasing the torque transmission capacity, and the compensation torque, whose polarity was inverted at step 6, is set at 0. Since the changeover to the hybrid running mode is completed by these executions in this program, the program is terminated.

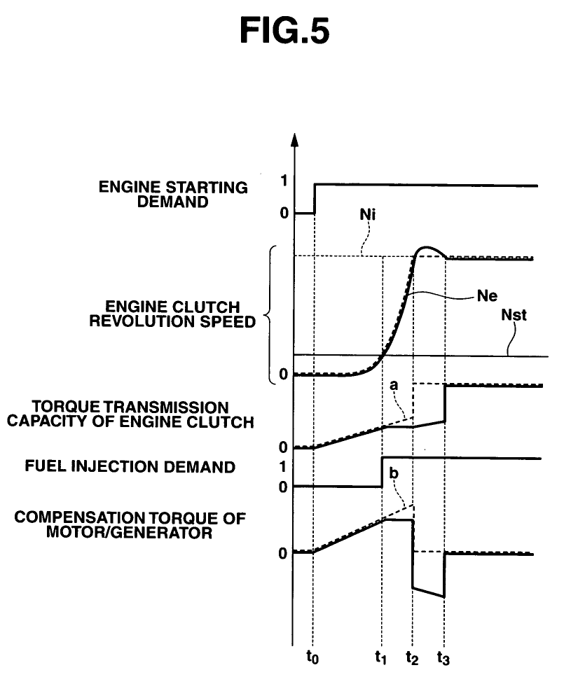

Subsequently, there are discussed the operation and the merit of the engine starting control apparatus according to the embodiment of the present invention in a case that the compensation torque is momentarily inverted, on the basis of a timing chart shown in FIG. 5.

Before moment t0, the electric running mode is selected and therefore the hybrid vehicle runs only by the output torques of motor/generators MG1 and MG2. Engine clutch 9 is disengaged, and therefore the torque transmission capacity is 0. Engine ENG is stopped and therefore the engine revolution speed Ne is 0.

When the command of demanding engine starting is generated after moment t0 (corresponding to the affirmative determination at step S1), the torque transmission capacity of engine clutch 9 is gradually increased from 0 with a ramp.

Further, the output torques of motor/generators MG1 and MG2 are gradually increased with a ramp after moment t0 (corresponding to the execution of step S2). Engine clutch 9 transfers the compensation torque to engine ENG as a cranking torque. Therefore, the engine revolution speed Ne increases from 0.

When the engine revolution speed under increasing state reaches the engine start enabling revolution speed Nst at moment t1 (corresponding to the affirmative determination at step S3), the torque transmission capacity is held during a period from moment t1 to moment t2, and the firing of engine ENG is started (corresponding to the execution of step S4). Therefore, engine ENG starts rotating by firing, and the engine revolution speed Ne sharply increases during a period from moment t1 to moment t2. However, since the revolution speed Ni of the transmission-side friction element is greater than the revolution speed Ne of the engine-side friction element, the revolution speed Ni is dragged by the engine revolution speed Ne.

Although this dragging in engine clutch 9 functions to brake the motor/generators MG1 and MG2, which are drivingly connected to the transmission-side friction element of engine clutch 9, the expansion of the dragging of motor/generators MG1 and MG2 to engine ENG is prevented by temporally holding the torque transmission capacity. In other words, it becomes possible to prevent the increase of the dragging toque, which is applied from engine ENG to motor/generators MG1 and MG2 by this temporal holding.

Since the torque transmission capacity is temporarily held, that is, since engine clutch 9 is put in a slipping engagement state, the engine revolution speed Ne overshoots the transmission-side revolution speed Ni. Therefore, when the difference Ni−Ne becomes within a predetermined threshold such as 0 at moment t2, that is, when the transmission revolution speed Ni becomes equal to engine revolution speed Ne (corresponding to the affirmative determination at step S5), the polarity of the compensation torque of motor/generators MG1 and MG2 is inverted (corresponding to the execution of step S6). Accordingly, the compensation torque, which has had a positive value (cranking torque) before moment t2, becomes a negative value (braking torque) after moment t2.

By applying the braking torque to the transmission-side friction element, it becomes possible to prevent the excessive torque under the engine starting from being transferred to a load side (driving wheel side) relative to the transmission after moment t2.

That is, according to the embodiment of the present invention, during a period when the revolution speed of the engine-side friction element of engine clutch 9 overshoots the revolution speed of the transmission-side friction element, the transmission-side friction element applies the braking force toward the output. Therefore, it becomes possible to prevent the shock due to the increase of the engine output torque during the engine starting from being transferred to a load side (driving wheel side) connected to the transmission.

After moment t2 when the engine revolution speed Ne is greater than transmission-side revolution speed Ni (corresponding to the affirmative determination at step S7), the torque transmission capacity of engine clutch 9 is gradually increased with the predetermined ramp and the braking torque of motor/generator MG1 and MG2 is also gradually increased with the second ramp (corresponding to the execution of step S8). When the braking torque is gradually increased in magnitude with the ramp, the increasing state thereof is represented by a gradual decrease in FIG. 5.

Thus, motor/generators MG1 and MG2 output the braking torque, which was obtained by inverting the polarity of the cranking torque, as a compensation torque, and simultaneously the torque transmission capacity of engine clutch 9 is gradually increased so that the compensation torque is applied to engine ENG. This arrangement ensures the following merits. That is, the engine revolution speed Ne, which has overshot the transmission-side revolution speed Ni after moment t2, rapidly approached the transmission-side revolution speed Ni, without transferring the excessive torque during the engine starting to the load side (driving wheel side) connected to the hybrid transmission 1. Therefore, at moment t3 when the engine revolution speed Ne becomes nearly equal to the transmission-side revolution speed Ni, the torque transmission capacity of engine clutch 9 is sufficiently increased so that engine clutch 9 is fully engaged. Simultaneously, the compensation torque of motor/generators MG1 and MG2 is set at 0.

At moment t3 when the engine revolution speed Ne becomes nearly equal to the revolution speed Ni of the transmission-side friction element after moment t2 (corresponding to the affirmative determination at step S9), engine clutch 9 is fully engaged, and the compensation torque is set at 0 (corresponding to the execution of step S10). As a result of the execution, the engine revolution speed Ne is brought in line with the revolution speed Ni of the transmission-side friction element. Thereafter, the hybrid running mode is started.

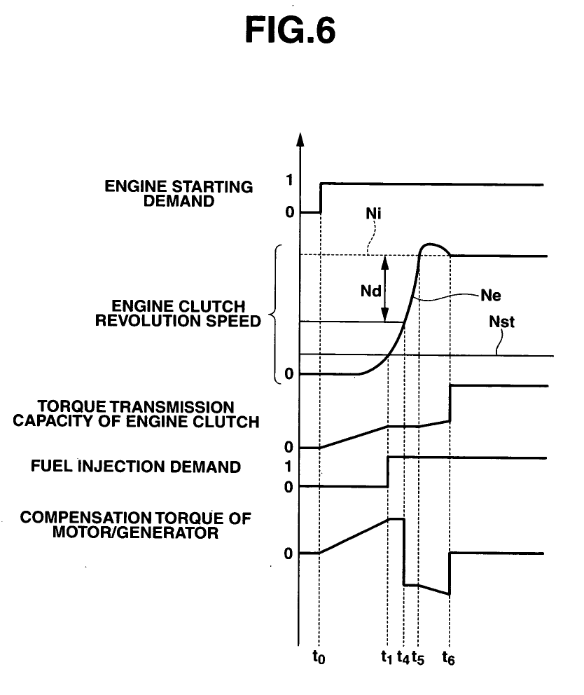

Subsequently, there are discussed the operation and the merit of the engine starting control apparatus according to the embodiment of the present invention, in a case that the predetermined threshold employed at step S5 is set at a predetermined revolution speed Nd of a positive value, with reference to the timing chart in FIG. 6.

The operation and the merit during a period from moment t0 to moment t1 in FIG. 6 are the same as those discussed above.

Until moment t4 following moment t1, the torque transmission capacity is held, and the firing of engine ENG is started (corresponding to the execution of step S4). When the difference Ni−Ne becomes smaller than the predetermined threshold Nd at moment t4 (corresponding to the affirmative determination at step S5), the polarity of the compensation torque of motor/generators MG1 and MG2 is inverted after moment t4 (corresponding to the execution of step S6). Accordingly, the compensation torque has a negative value (braking torque) after moment t4 although the compensation torque has had a positive value (cranking torque) before moment t4.

Accordingly, at moment t4, which is slightly before moment t5 when the engine revolution speed Ne starts to overshoot the transmission-side revolution speed Ni, a sign of the overshoot is detected, and engine clutch 9 transfers the braking torque from the engine-side friction element to the transmission-side friction element. Therefore, when it is anticipated that the response delay of the output of motor/generators MG1 and MG2 is generated, it becomes possible to absorb the response delay, and thereby preventing the engine revolution speed Ne from excessively becoming greater than the transmission-side revolution speed Ni in a manner of suppressing the engine revolution speed Ne from sharply increasing after moment t5.

The predetermined revolution speed (predetermined threshold) Nd is determined taking account of the characteristic of motor/generators MG1 and MG2 and the characteristic of engine ENG. More specifically, in view of the characteristic of engine ENG, when an increasing rate of change of the engine revolution speed Ne per unit time after the engine starting is large, such as a case that the engine revolution speed Ne sharply increases after moment t1 in FIG. 6, the predetermined threshold Nd is increased.

After moment t5, it is detected that the engine revolution speed Ne overshot the transmission-side revolution speed Ni (corresponding to the affirmative determination at step S7). After moment t5, the braking torque of motor/generators MG1 and MG2 is gradually increased, and simultaneously the torque transmission capacity of engine clutch 9 is gradually increased so that the braking torque is transferred. This operation corresponds to the execution of step S8.

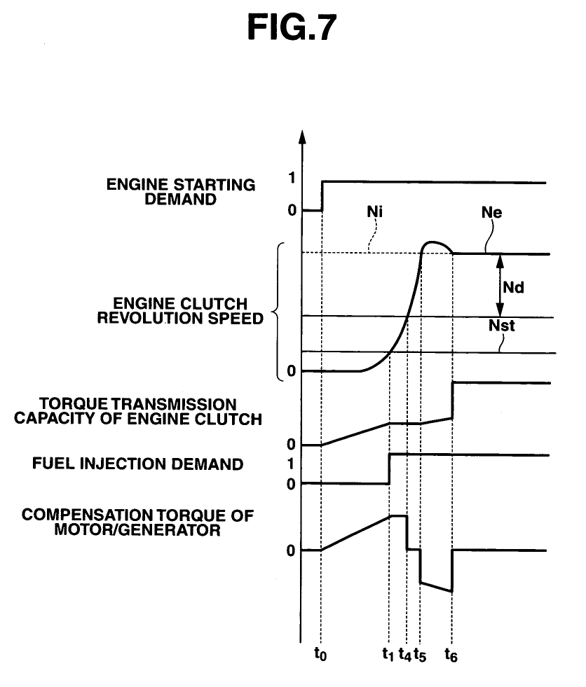

Subsequently, there are discussed the operation and the merit of the engine starting control apparatus according to the embodiment of the present invention in a case that the compensation torque is temporally held when the polarity of the compensation torque is inverted at step S6, with reference to a timing chart shown in FIG. 7.

The operation and the merit during a period from moment t0 to moment t4 in FIG. 7 are the same as those discussed above.

When the difference Ni−Ne becomes smaller than the predetermined threshold Nd at moment t4 (corresponding to the affirmative determination at step S5), the compensation torque of motor/generators MG1 and MG2 are firstly held at 0 after moment t4 (corresponding to the execution of step S6).

After moment t5, it is determined that the engine revolution speed Ne overshot the transmission-side revolution speed Ni (corresponding to the affirmative determination at step S7. After moment t5, the braking torque is gradually increased by varying the compensation torque of motor/generators MG1 and MG2 from 0 to the braking torque, and simultaneously the torque transmission capacity of engine clutch 9 is gradually increased so that engine clutch 9 can transfer the braking torque (corresponding to the execution of step S8).

When the polarity of the compensation torque of motor/generators MG1 and MG2 is inverted from the cranking torque of a positive value to the braking torque of a negative value, by temporally holding the compensation torque at 0, it becomes possible to gain the following merit. That is, even when it is difficult to ensure the accuracy of a timing setting for inverting the compensation torque, it becomes possible to suppress the generation of the excessive shock without momentarily executing the inversion of the polarity of the compensation torque during a short period from the end of the engine firing to the start of the overshoot at step S6.

The operation and the merit during the period from moment t5 to moment t6 are the same as those discussed above.

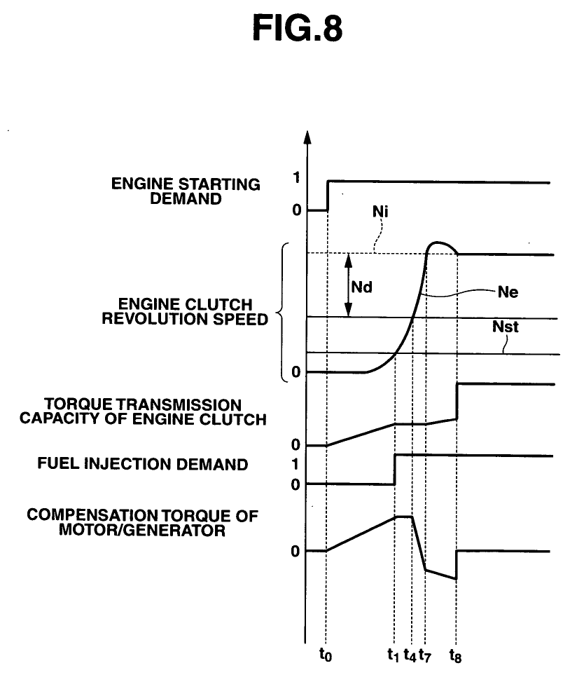

Subsequently, there are discussed the operation and the merit of the engine starting control apparatus according to the embodiment of the present invention in a case that the polarity of the compensation torque of motor/generators MG1 and MG2 is inverted by a constant rate of change per unit time, with reference to a timing chart shown in FIG. 8.

The operation and the merit during the period from moment t0 to moment t4 in FIG. 8 are the same as those discussed above.

When the difference Ni−Ne becomes smaller than or equal to the predetermined threshold Nd at moment t4 (corresponding to the affirmative determination at step S5), the compensation torque of motor/generators MG1 and MG2 is decreased with a constant ramp after moment t4 (corresponding to the execution of step S6). At moment within a period between moment t4 and moment t1, the compensation torque of motor generator reaches 0, and thereafter the compensation torque is continuously decreased with a constant ramp. By this processing, the compensation torque is inverted from the cranking torque of a positive value to the braking torque of a negative value.

After moment t7, it is determined that the engine revolution speed Ne overshot the transmission-side revolution speed Ni (corresponding to the affirmative determination at step S7). After moment t7, the braking torque of motor/generators MG1 and MG2 is gradually increased in magnitude with a predetermined ramp, and simultaneously the torque transmission capacity of engine clutch 9 is gradually increased so that engine clutch 9 can transfer the braking torque (corresponding to the execution of step S8).

When the polarity of the compensation torque of motor/generators MG1 and MG2 is inverted from the cranking torque of a positive value to the braking torque of a negative value, by varying the compensation torque by the constant rate of change per unit time, it becomes possible to gain the following merit. That is, even when it is difficult to ensure the accuracy of a timing setting for inverting the compensation torque, it becomes possible to suppress the generation of the excessive shock, without momentarily executing the inversion of the polarity of the compensation torque during a short period from the end of the engine firing to the start of the overshoot at step S6.

After moment t7 and at moment t8 when the engine revolution speed Ne becomes nearly equal to the revolution speed Ni of the transmission-side friction element (corresponding to the affirmative determination at step S9), engine clutch 9 is fully engaged and the compensation torque is set at 0 (corresponding to the execution of step S10).

As a result, the engine revolution speed Ne is brought in line with the revolution speed Ni of the transmission-side friction element, and therefore the hybrid running mode is started.

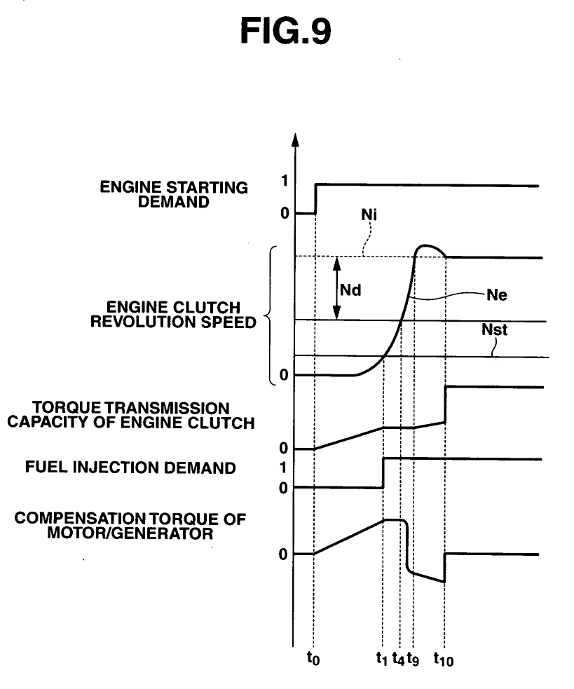

Subsequently, there are discussed the operation and the merit of the engine starting control apparatus according to the present invention, in a case that the polarity of the compensation torque of motor/generators MG1 and MG2 is inverted using one of trigonometric functions, with reference to a timing chart shown in FIG. 9.

The operation and the merit during a period from moment t0 to moment t4 in FIG. 9 are the same as those discussed above.

When the difference Ni−Ne becomes smaller than the predetermined threshold Nd at moment t4 (corresponding to the affirmative determination at step S5), the compensation torque of motor/generators MG1 and MG2 is decreased from the maximum value of a positive value to the minimum value of a negative value using the following expression (1) after moment t4 (corresponding to the execution of step S6).
T=K tan h(k·t) (1)

The expression (1) is a hyperbolic tangent function by which the compensation torque T of motor/generators MG1 and MG2 is inverted for a predetermined time period. Herein K and k are constants, t is a time period (parameter) from a polarity inversion starting moment t4 to moment of the inversion. When t=0, T has the maximum value of a positive value. When t=t9−t4, T has the minimum value of a negative value (smallest magnitude), and the polarity of the compensation torque is inverted during the period t.

After moment t9, it is detected that the engine revolution speed Ne overshot the transmission-side revolution speed Ni (corresponding to the affirmative determination at step S7). After moment t9, the braking torque of motor/generators MG1 and MG2 is gradually increased with the ramp, and simultaneously the torque transmission capacity of engine torque 9 is gradually increased so as to transfer the braking torque (corresponding to step S8).

When the polarity of the compensation torque of motor/generators MG1 and MG2 is inverted from the cranking torque of a positive value to the braking torque of a negative value, by varying the compensation torque using one of trigonometric functions, it becomes possible to gain the following merit. That is, even when it is difficult to ensure the accuracy of a timing setting for inverting the compensation torque, it becomes possible to suppress the generation of the excessive shock without momentarily executing the inversion of the polarity of the compensation torque during a short period from the engine firing to the start of the overshoot at step S6. Further it becomes possible to smoothly invert the polarity of the compensation torque according to the output characteristic of motor/generators MG1 and MG2, and it becomes possible to execute a drive operation which decreases the load applied to motor/generators MG1 and MG2.

Although not concretely shown in Figures, instead of the hyperbolic tangent function T=K tan h (k·t), an arctangent function T=K atan(k·t), a cosine function T=K cos(k·t), or a sine function T=K sin(k·t) may be employed. Herein, T is the compensation torque, K and k are constants, t is a time period (parameter) from the polarity inversion starting moment to moment. Although not shown in Figures, when the polarity of the compensation torque is momentarily inverted at step S6, there may be a combination of at least two of momentarily and continuously varying the compensation torque, temporally holding the compensation torque at 0, varying the compensation torque at a constant rate of change per unit time (constant ramp), and smoothly varying the compensation torque using a trigonometric function.

After moment t9 and at moment t10 when the engine revolution speed Ne becomes nearly equal to the revolution speed Ni of the transmission-side friction element (corresponding to the affirmative determination at step S9), engine clutch 9 is fully engaged, and the compensation torque is set at 0 (corresponding to the execution of step S10). At a result, the engine revolution speed Ne is brought in line with the revolution speed of the transmission-side friction element, and therefore the hybrid running mode is started.

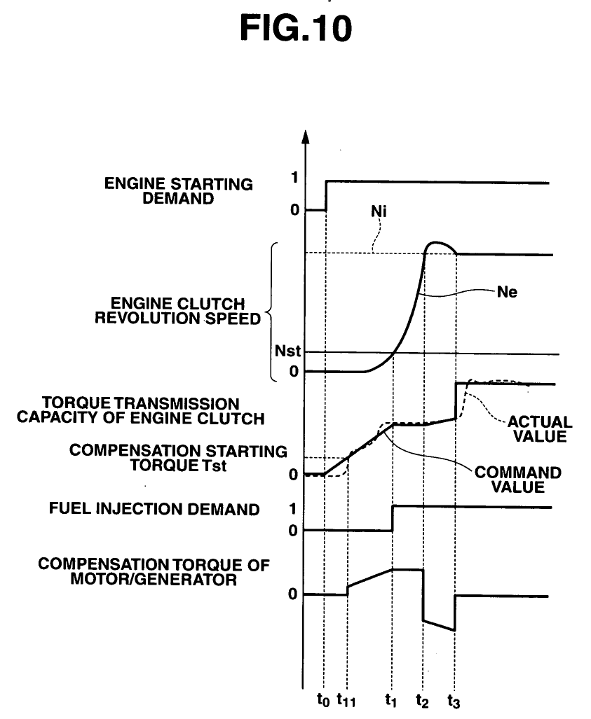

Subsequently, there is discussed the operation and the merit of the compensation torque control taking account of the response delay of engine clutch 9, with reference to a timing chart shown in FIG. 10.

When the engine starting demand of engine ENG is raised up after moment t0 (corresponding to the affirmative determination at step S1), the torque transmission capacity command value of engine clutch 9 is gradually increased from 0 with a ramp as shown by a continuous line in FIG. 10.

In contrast, the actual torque transmission capacity (actual value) starts increasing after moment t0 as shown by a broken line. This is caused by the reason that the operation of engine clutch 9 is attended with a response delay of the hydraulic line. Therefore, at moment t11 when the torque transmission capacity command value reaches the compensation starting torque Tst, a command value of the compensation torque ΣΔTi of motor/generators MG1 and MG2 is set at Tst so as to gradually increase the compensation torque command value with a ramp after moment t11. The moment t11 is located between moment t0 and moment t1.

With this arrangement, engine clutch 9 applies the compensation torque (≧tTst) of motor/generators MG1 and MG2 to engine ENG as a cranking torque. The engine revolution speed Ne increases from 0. When the engine speed Ne in increasing state reaches the engine start enabling revolution speed Nst at moment t1 (corresponding to the affirmative determination at step S3), engine ENG is started by starting the firing and the fuel injection, and therefore the engine revolution speed Ne sharply increases during a period from moment t1 to moment t2. Further the torque transmission capacity is held during the period from moment t1 to moment t2. This processing corresponds to the execution at step S4.

When the difference Ni−Ne becomes 0 of the predetermined threshold at moment t2, that is, when the transmission-side revolution speed Ni becomes nearly equal to the engine revolution speed Ne (corresponding to the affirmative determination at step S5), the polarity of the compensation torque of motor/generators MG1 and MG2 is inverted after moment t2 (corresponding to the execution of step S6). Accordingly, the compensation torque becomes a negative value (braking torque) after moment t2 although it was a positive value (cranking torque) before moment t2. By applying the braking torque to the transmission side, it becomes possible to suppress the generation of an excessive shock after moment t2.

During a period from moment t2 to moment t3, during which the engine revolution speed Ne is greater than the transmission-side revolution speed Ni (corresponding to the affirmative determination at step S7), the torque transmission capacity of engine clutch 9 is gradually increased with a ramp, and therefore the compensation torque (braking torque) of motor/generators MG1 and MG2 is gradually increased with the ramp (corresponding to the execution of step S8). As a result, the engine revolution speed Ne approaches the revolution speed Ni of the transmission-side friction element.

After moment t2 and at moment t3 when the engine revolution speed Ne becomes nearly equal to the revolution speed Ni of the transmission-side friction element (corresponding to the affirmative determination at step S9), engine clutch 9 is fully engaged, and the compensation torque is set at 0 (corresponding to the execution of step S10). As a result, the engine revolution speed Ne is brought in line with the revolution speed Ni of the transmission-side friction element, and therefore the hybrid running mode is started.

The embodiment shown in FIG. 10 in accordance with the present invention is arranged to take account of the response delay of the torque transmission capacity of engine clutch 9 in contrast with the extremely high responsibility of the output torque of motor/generators MG1 and MG2. More specifically, since the compensation torque command value is gradually increased from moment t11 in contrast that the torque transmission capacity command value is gradually increased from moment t1, it becomes possible to generally adjust the actual value (a broken line in FIG. 10) of the torque transmission capacity with the actual value (equal to the continuous line in FIG. 10) of the compensation torque, and therefore it becomes possible to effectively operate motor/generators MG1 and MG2.

In the above explanations, the compensation torques of motor/generators MG1 and MG2 are summed and represented by one line in each timing chart of FIGS. 5 through 10. The compensation torque discussed herein may be only ΔT1, ΔT2 or a total ΔT1+ΔT2 of them.

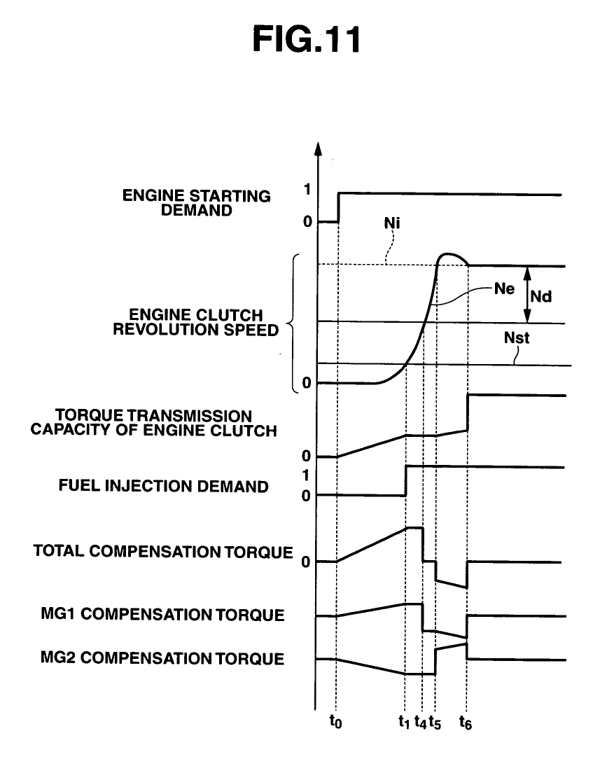

Subsequently, there are discussed the operation and the merit of the engine starting control apparatus according to the present invention in a case that the compensation torque ΔT1 of first motor/generator MG1 and the compensation torque ΔT2 of second motor/generator MG2 are separately controlled, with reference to timing charts shown in FIGS. 11 through 13.

FIG. 11 shows a timing chart of the engine starting control apparatus according to the embodiment of the present invention in a case that the compensation torque is temporally held at 0, and the polarity thereof is then inverted. When the polarity of the compensation torque is inverted at step S6, the total of the compensation torques is temporally held at 0. More specifically, only the compensation torque ΔT1 of first motor/generator MG1 is temporally set at 0, and the polarity of the compensation torque ΔT2 of second motor/generator MG2 is momentarily inverted.

When the engine starting demand is commanded at moment t0, the torque transmission capacity of engine clutch 9 is gradually increased from 0 after moment t1. Further, the compensation torque ΔT1 of first motor/generator MG1 is gradually increased from 0 to a positive value, and the compensation torque ΔT2 of second motor/generator MG2 is gradually decreased from 0 to a negative value. The reason thereof is that as shown in the lever diagram of FIG. 2, the compensation torque ΔT1 has a positive direction, and the compensation torque ΔT2 has a negative direction. As a result, the total ΔT1+ΔT2 of the compensation torques ΔT1 and ΔT2 gradually increases. The cranking is executed and the revolution speed Ne is increased after the total of the compensation torques gradually increases and the torque transmission capacity gradually increases.

When the engine revolution speed Ne reaches the engine start enabling revolution speed Nst at moment t1 (corresponding to the affirmative determination at step S3), the torque transmission capacity is held at a value taken just before (corresponding to step S4) after moment t1. Further, the compensation torque ΔT1 is also held at a value taken just before, and the compensation torque ΔT2 is also held at a value taken just before. As a result, the total of the compensation torques is also held at a value taken just before. By the firing and the fuel injection demand (corresponding to the execution of step S4), engine ENG is cranked and therefore the revolution speed of engine ENG is sharply increased.

When the difference Ni−Ne becomes the predetermined threshold Nd at moment t4 (corresponding to the affirmative determination at step S5), the polarity of the compensation torque ΔT1 of first motor/generator MG1 is inverted from a positive value to a negative value (corresponding to the executing of step S6), and the negative value is held after moment t4. In contrast, the compensation torque ΔT2 of second motor/generator MG2 is held at a value (negative value) taken just before moment t4 (this is also executed at step S6 in FIG. 4). As a result, the total of the compensation torques is generally held at 0. After moment t4, the torque transmission capacity is held at a value taken just before (corresponding to the execution of step S4).

After moment t5, it is detected that the engine revolution speed Ne overshot the transmission-side revolution speed Ni (corresponding to the affirmative determination at step S7). After moment t5, the compensation value ΔT1 of a negative value is gradually decreased. That is, since the braking torque is gradually increased in magnitude, the braking torque is represented in FIG. 11 so as to be decreased in the downward direction. On the other hand, by inverting the polarity of the compensation torque ΔT2 from a negative value to a positive value at moment t5, the compensation torque ΔT2 of the positive value is gradually increased after moment t5. As a result, the total of the compensation torques performs as a braking torque of a negative value, and the braking torque is gradually increased in magnitude although it is represented in FIG. 11 so as to be gradually decreased.

After moment t5, the torque transmission capacity of engine clutch 9 is gradually increased so as to transmit the braking torque (corresponding to the execution of step S8).

When the engine revolution speed Ne becomes nearly equal to the transmission-side revolution speed Ni at moment t6 (corresponding to step S9), engine clutch 9 is fully engaged and compensation torques ΔT1 and ΔT2 are set at 0, respectively, after moment t6.

Thus, when the polarity of the total of the compensation torques of motor/generators MG1 and MG2 is inverted from the positive-value cranking torque to the negative-value braking torque, the compensation torque ΔT1 and the compensation torque ΔT2 are separately and independently controlled. More specifically, by inverting the polarity of the compensation torque ΔT1 at moment t4 and by inverting the polarity of compensation torque ΔT2 at moment t5, the following merit is obtained. That is, even when it is difficult to ensure the accuracy of the timing setting for inverting the polarity of the compensation torque although both of first motor/generator MG1 and second motor/generator have high responsibility, it becomes possible to suppress the generation of excessive shock thereby.

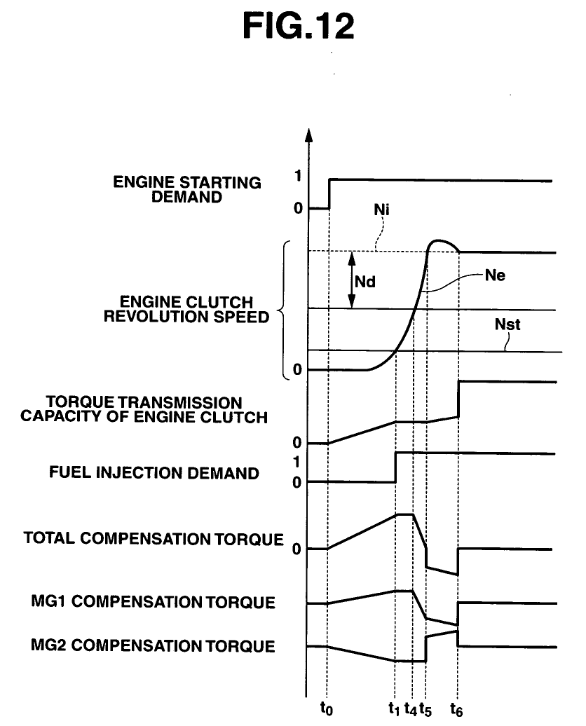

FIG. 12 shows a timing chart of the engine starting control apparatus according to the embodiment of the present invention, in a case that the polarity of the compensation torque is inverted at a constant rate of change per unit time. When the polarity of the compensation torque is inverted at step S6, the polarity of the total of the compensation torques is inverted at the constant rate of change per unit time. More specifically, only the polarity of the compensation torque ΔT1 of first motor/generator MG1 is inverted at the constant rate of change per unit time, and the polarity of the compensation torque ΔT2 of second motor/generator MG2 is momentarily inverted.

The operation and the merit during the period from moment t0 to moment t4 in FIG. 12 are the same as those discussed above.

When the difference Ni−Ne becomes smaller than or equal to the predetermined threshold Nd at moment t4 (corresponding to the affirmative determination at step S5), the polarity of the compensation torque ΔT1 of first motor/generator MG1 is inverted by decreasing the compensation torque ΔT1 from a positive value to a negative value at a constant rate of change per unit time after moment t4 (corresponding to the execution of step S6). In contrast, the compensation torque ΔT2 of second motor/generator MG2 is held at a negative value taken just before moment t4 (this is executed by step S6 in FIG. 4). As a result, the total of the compensation torques is decreased from a positive value by a constant rate of change per unit time. After moment t4, the torque transmission capacity is held at a value taken just before moment t4.

After moment t5, it is detected that the engine revolution speed Ne overshot the transmission-side revolution speed Ni (corresponding to the affirmative determination at step S7). After moment t5 the compensation value ΔT1 of a negative value is gradually decreased. That is, although the braking torque is gradually increased in magnitude, the braking torque is represented in FIG. 12 so as to be decreased in the downward direction. On the other hand, by inverting the polarity of the compensation torque ΔT2 from a negative value to a positive value at moment t5, the compensation torque ΔT2 of the positive value is gradually increased after moment t5. As a result, the total of the compensation torques performs as a braking torque of a negative value, and the braking torque is gradually increased in magnitude although it is represented in FIG. 12 so as to be gradually decreased. After moment t5, the torque transmission capacity of engine clutch 9 is gradually increased so as to transmit the braking torque (corresponding to the execution of step S8).

At moment t6 when the engine revolution speed Ne becomes nearly equal to the transmission-side revolution speed Ni (corresponding to step S9), engine clutch 9 is fully engaged and compensation torques ΔT1 and ΔT2 are set at 0, respectively, after moment t6.

Thus, when the polarity of the total of the compensation torques of motor/generators MG1 and MG2 is inverted from the positive-value cranking torque to the negative-value braking torque, the compensation torque ΔT1 and the compensation torque ΔT2 are separately and independently controlled. More specifically, by inverting the polarity of the compensation torque ΔT1 at moment t4 at the constant rate of change per unit time and by momentarily inverting the polarity of compensation torque ΔT2, the following merit is obtained. That is, even when first motor/generator MG1 is big in size and low in responsibility and the second motor/generator MG2 is small in size and high in responsibility, it becomes possible to suppress the generation of excessive shock thereby.

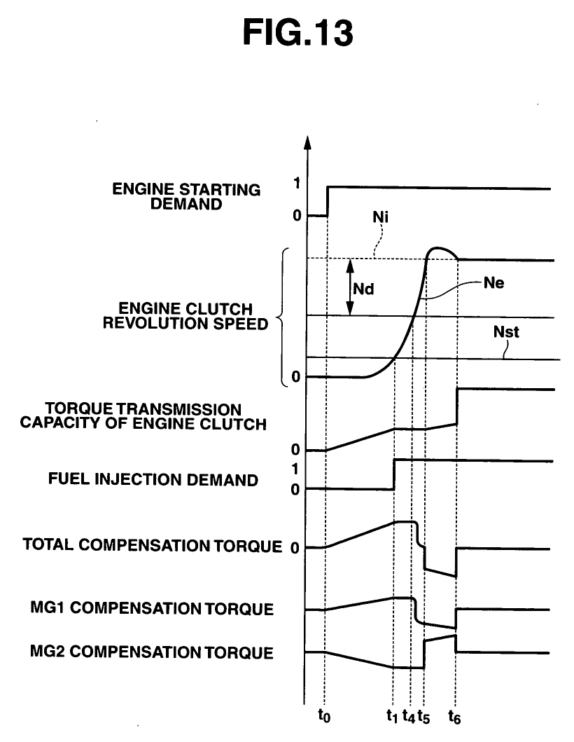

FIG. 13 shows a timing chart of the engine staring control apparatus according to the embodiment of the present invention, in a case that the polarity of the compensation torque is inverted on the basis of a predetermined trigonometric function. When the polarity of the compensation torque is inverted at step S6, the polarity of the total of the compensation torques is smoothly inverted so as to form a curve of a hyperbolic tangent. More specifically, only the polarity of the compensation torque ΔT1 of first motor/generator MG1 is inverted so as to form a curve of a hyperbolic tangent, and the polarity of the compensation torque ΔT2 of second motor/generator MG2 is momentarily inverted.

The operation and the merit during the period from moment t0 to moment t4 in FIG. 13 are the same as those discussed above.

When the difference Ni−Ne becomes smaller than or equal to the predetermined threshold Nd at moment t4 (corresponding to the affirmative determination at step S5), the compensation torque ΔT1 of first motor/generator MG1 is decreased from a positive value by a curve of a hyperbolic tangent and is then held at 0 until moment t5, (corresponding to the execution of step S6). Moment t5 is the moment when the engine-side revolution speed Ne reaches the transmission-side revolution speed Ni, and is the moment when the affirmative determination is firstly outputted at step S7. Accordingly, the moment t5 is delayed as the transmission-side revolution speed Ni becomes higher. The meaning of holding the compensation toque ΔT1 of first motor/generator MG1 at 0 until moment t5 is to decrease the compensation toque ΔT1 by moment t5, upon taking account of the transmission-side revolution speed Ni during a normal running.

In contrast, the compensation torque ΔT2 of second motor/generator MG2 is held at a negative value taken just before moment t4. This is executed at step S6 in FIG. 4. As a result, the total of the compensation torques is smoothly decreased from a positive value to 0. After moment t4, the torque transmission capacity is held at a value taken just before moment t4.

After moment t5, it is detected that the engine revolution speed Ne overshot the transmission-side revolution speed Ni (corresponding to the affirmative determination at step S7). After moment t5 the compensation value ΔT1 of a negative value is gradually decreased. That is, since the braking torque is gradually increased in magnitude, the braking torque is represented in FIG. 13 so as to be decreased in the downward direction. On the other hand, by inverting the polarity of the compensation torque ΔT2 from a negative value to a positive value at moment t5, the compensation torque ΔT2 of the positive value is gradually increased after moment t5. As a result, the total of the compensation torques performs as a braking torque of a negative value, and the braking torque is gradually increased in magnitude although it is represented in FIG. 13 so as to be gradually decreased.

After moment t5, the torque transmission capacity of engine clutch 9 is gradually increased so as to transmit the braking torque (corresponding to the execution of step S8).

When the engine revolution speed Ne becomes nearly equal to the transmission-side revolution speed Ni at moment t6 (corresponding to the affirmative determination of step S9), engine clutch 9 is fully engaged and compensation torques ΔT1 and ΔT2 are set at 0, respectively, after moment t6.

Thus, when the polarity of the total of the compensation torques of motor/generators MG1 and MG2 is inverted from the positive-value cranking torque to the negative-value braking torque, the compensation torque ΔT1 and the compensation torque ΔT2 are separately and independently controlled. More specifically, by inverting the polarity of the compensation torque ΔT1 using the predetermined trigonometric function and by momentarily inverting the polarity of compensation torque ΔT2 at moment t5, the following merit is obtained. That is, even when first motor/generator MG1 is large in size and low in responsibility, and second motor/generator MG2 is small in size and high in responsibility, it becomes possible to execute the polarity inversion of the compensation torque ΔT1 with less unreasonableness.

This application is based on Japanese Patent Application No. 2005-304789 filed on Oct. 19, 2005 in Japan. The entire contents of this Japanese Patent Application are incorporated herein by reference.

Although the invention has been described above by reference to certain embodiments of the invention, the invention is not limited to the embodiments described above. Modifications and variations of the embodiments described above will occur to those skilled in the art, in light of the above teaching. The scope of the invention is defined with reference to the following claims.

What is claimed is:

1. An engine staring control apparatus of a hybrid drive system, the hybrid drive system constructed by drivingly connecting a hybrid transmission equipped with a motor/generator as a driving source and an internal combustion engine through a friction engagement element, the engine starting control apparatus comprising:
a friction engagement element controlling section controlling a torque transmission capacity of the friction engagement element;
a torque controlling section controlling a torque outputted from the motor/generator;
an engine-side revolution speed calculating section obtaining a revolution speed of an engine-side friction element of the friction engagement element;
a transmission-side revolution speed calculating section obtaining a revolution speed of a transmission-side friction element of the friction engagement element;.
the torque controlling section compensating a cranking torque when the engine is started;
the friction engagement element controlling section increasing the torque transmission capacity when the engine is started;
the friction engagement element controlling section stopping the increase of the torque transmission capacity and holding the torque transmission capacity when the revolution speed of the engine-side friction element reaches a revolution speed at which the engine can start by itself; and
the friction engagement element controlling section stopping the holding of the torque transmission capacity and again increasing the torque transmission capacity when the revolution speed of the engine-side friction element reaches the revolution speed of the transmission-side friction element.

2. The engine starting control apparatus as claimed in claim 1, wherein the torque controlling section outputs a braking torque obtained by inverting a polarity of the cranking torque when the revolution speed of the engine-side friction element becomes higher than the revolution speed of the transmission-side friction element after the engine starting.

3. The engine starting control apparatus as claimed in claim 2, wherein the torque controlling section applies the braking torque to the engine after the engine starting and from moment before the revolution speed of the engine-side friction element becomes higher than the revolution speed of the transmission-side friction element.

4. The engine starting control apparatus as claimed in claim 3, wherein the torque controlling section applies the braking toque to the engine when a difference between the revolution speed of the engine-side friction element and the revolution speed of the transmission-side friction element becomes smaller than a predetermined value after the engine starting.

5. The engine starting control apparatus as claimed in claim 4, wherein the torque controlling section determines the predetermined value on the basis of a rate of increase of the engine revolution speed per unit time.

6. The engine starting control apparatus as claimed in claim 2, wherein the torque controlling section temporally holds the torque outputted from the motor/generator at 0 when the polarity of the torque is inverted.

7. The engine starting control apparatus as claimed in claim 2, wherein the torque controlling section inverts the polarity of the torque at a constant rate of change per unit time.

8. The engine starting control apparatus as claimed in claim 2, wherein the torque controlling section inverts the polarity of the torque using a trigonometric function.

9. The engine starting control apparatus as claimed in claim 2, wherein for starting the engine, the friction engagement element controlling section increases a command value of the torque transmission capacity from 0 before staring the engine, and the torque controlling section starts outputting a cranking torque to the engine at moment when the command value reaches a predetermined value.

10. The engine starting control apparatus as claimed in claim 1, wherein the friction engagement element controlling section increases the torque transmission capacity from moment when the revolution speed of the engine-side friction element under a revolution speed increasing state becomes nearly equal to the revolution speed of the transmission-side revolution speed just after the engine starts by the cranking torque, and the friction engagement element controlling section fully engages the engine-side friction element and the transmission-side friction element at moment when the revolution speed of the engine-side friction element under a revolution speed decreasing state becomes nearly equal to the revolution speed of the transmission-side friction element.

11. The engine starting control apparatus as claimed in claim 1, wherein the motor/generator includes at least two motor/generators, the hybrid transmission is constructed by a differential device of a two-degree-of-freedom which has an input friction element of drivingly connecting the engine and the hybrid transmission, at least two input friction elements of drivingly connecting the motor/generators and the hybrid transmission, and an output shaft element, and wherein at least one of the motor/generators is high in responsibility.

12. A method for controlling a starting of an internal combustion engine of a hybrid drive system, the hybrid drive system constructed by drivingly connecting a hybrid transmission equipped with a motor/generator as a driving source and the engine through a friction engagement element, the engine starting control method comprising:
obtaining a revolution speed of an engine-side friction element of the friction engagement element;
obtaining a revolution speed of a transmission-side friction element of the friction engagement element;
increasing a torque transmission capacity of the friction engagement element and compensating a cranking torque outputted from the motor/generator when the engine is started;
stopping the increase of the torque transmission capacity and holding the torque transmission capacity when the revolution speed of the engine-side friction element reaches a revolution speed at which the engine can start by itself; and
stopping the holding of the torque transmission capacity and again increasing the torque transmission capacity when the revolution speed of the engine-side friction element reaches the revolution speed of the transmission-side friction element.

13. An engine staring control apparatus of a hybrid drive system, the hybrid drive system constructed by drivingly connecting a hybrid transmission equipped with a motor/generator as a driving source and an internal combustion engine through a friction element, the engine starting control apparatus comprising:
a controller programmed,
to obtain a revolution speed of an engine-side friction element of the friction engagement element,
to obtain a revolution speed of a transmission-side friction element of the friction engagement element,
to compensate a cranking torque when it is determined that the engine is started,
to increase the torque transmission capacity when it is determined that the engine is started,
to stop the increase of the torque transmission capacity when the revolution speed of the engine-side friction element reaches a revolution speed at which the engine can start by itself,
to hold the torque transmission capacity when the revolution speed of the engine-side friction element reaches the revolution speed at which the engine can start by itself,
to stop the holding of the torque transmission capacity just after the revolution speed of an engine-side friction element temporally becomes higher than the revolution speed of the transmission-side friction element, and
to again increase the torque transmission capacity just after the revolution speed of an engine-side friction element temporally becomes higher than the revolution speed of the transmission-side friction element.

14. An engine staring control apparatus of a hybrid drive system, the hybrid drive system constructed by drivingly connecting a hybrid transmission equipped with a motor/generator as a driving source and an internal combustion engine through a friction element, the engine starting control apparatus comprising:
friction engagement element controlling means for controlling a torque transmission capacity of the friction engagement element;
torque controlling means for controlling a torque outputted from the motor/generator;
engine-side revolution speed calculating means for obtaining a revolution speed of an engine-side friction element of the friction engagement element;
transmission-side revolution speed calculating means for obtaining a revolution speed of a transmission-side friction element of the friction engagement element;
the torque controlling means compensating a cranking torque when the engine is started;
the friction engagement element controlling means increasing the torque transmission capacity when the engine is started;
the friction engagement element controlling means stopping the increase of the torque transmission capacity and holding the torque transmission capacity when the revolution speed of the engine-side friction element reaches a revolution speed at which the engine can starts by itself; and
the friction engagement element controlling means stopping the holding of the torque transmission capacity and again increasing the torque transmission capacity when the revolution speed of the engine-side friction element reaches the revolution speed of the transmission-side friction element.
